(19) United States
(12) Patent Application Publication
(10) Pub. No.: US 2025/0219342 A1
(43) Pub. Date: Jul. 3, 2025

(54) METHOD FOR PROVIDING PROTECTION FOR METAL JOINT

(71) Applicant: Tyco Electronics (Shanghai) Co., Ltd., Shanghai (CN)

(72) Inventors: Jinyu Zhang, Shanghai (CN); Yongjian (Justin) Huang, Shanghai (CN); Zhongxi Huang, Shanghai (CN); Tongbao (Tim) Ding, Shanghai (CN); Zhimin Zhang, Shanghai (CN)

(73) Assignee: Tyco Electronics (Shanghai) Co., Ltd., Shanghai (CN)

(21) Appl. No.: 19/001,783

(22) Filed: Dec. 26, 2024

(30) Foreign Application Priority Data
Dec. 28, 2023 (CN) 202311849421.7

(51) Int. Cl. H01R 43/00

(52) U.S. Cl. CPC H01R 43/005

(57) ABSTRACT

A method for providing protection for a metal joint, includes contacting an aluminum metal piece with a copper metal piece to form an electrical connection. The method also includes applying a coating on the surface of a contact between the aluminum metal piece and the copper metal piece to provide protection for the contact. The coating includes one of a polyurethane, an acrylic ester, and a polyolefin elastomer.

### CROSS-REFERENCE TO RELATED APPLICATION

This application claims the benefit of the filing date under 35 U.S.C. § 119 (a)-(d) of Chinese Patent Application No. 202311849421.7, filed on Dec. 28, 2023.

### FIELD OF THE INVENTION

The disclosure relates to a metal joint and, more particularly, to a method for providing protection for a metal joint.

### BACKGROUND OF THE INVENTION

Due to its low price and light weight, aluminum enameled wire is increasingly being used as a substitute for copper enameled wire. For example, in motor windings, the cost of aluminum enameled wire is even as low as one-fifth of copper enameled wire. In addition, the cold-pressed terminals currently used for connecting enameled wires are mostly made of copper. After the aluminum enameled wire is electrically connected to the copper terminal, if there are some chemical media such as water or salt in the environment, due to their different reactivity, the two are prone to form a galvanic effect, which may cause electrochemical corrosion of the aluminum enameled wire at the joint point. High current during a working state may cause a resistance increase at the joint point, and may also cause a high temperature, which further exacerbates the corrosion process. Thus, a cycle may be formed that ultimately leads to electrical connection failure.

In some engineering applications, operators may choose to use adhesives to apply glue at the joint points between enameled wires and terminals to slow down and avoid the occurrence of the above situation. However, since the joint points between enameled wires and terminals are usually only a few tens of micrometers in size, existing adhesives are difficult to fill and adhere to these joint points. Moreover, the corrosion resistance of adhesives are limited. When cured, the significant curing shrinkage of the adhesive may cause a resistance increase at the joint point and exacerbate the temperature rise effect.

### SUMMARY OF THE INVENTION

A method for providing protection for a metal joint, includes contacting an aluminum metal piece with a copper metal piece to form an electrical connection. The method also includes applying a coating on the surface of a contact between the aluminum metal piece and the copper metal piece to provide protection for the contact. The coating includes one of a polyurethane, an acrylic ester, and a polyolefin elastomer.

### BRIEF DESCRIPTION OF THE DRAWINGS

The invention will now be described by way of example with reference to the accompanying figures, of which:

FIG. 1 is a flowchart of a method for providing protection to a metal joint according to an embodiment;

FIG. 2 is a schematic perspective view of an applying step of the method of FIG. 1;

FIG. 3 is a top view of the applying step of the method of FIG. 1;

FIG. 4 is a graph showing results of damp heat testing and temperature shock testing on an enameled wire coated with a coating according to the method of FIG. 1 having a wire diameter of 0.3 mm;

FIG. 5 is a graph showing results of damp heat testing and temperature shock testing on the enameled wire coated with a coating according to the method of FIG. 1 having a wire diameter of 0.4 mm;

FIG. 6 is a graph showing the results of salt spray testing on the enameled wire coated with a coating according to the method of FIG. 1 having a wire diameter of 0.3 mm; and

FIG. 7 is a graph showing the results of salt spray testing on the enameled wire coated with a coating according to the method of FIG. 1 having a wire diameter of 0.4 mm.

### DETAILED DESCRIPTION OF THE EMBODIMENT(S)

Hereinafter, details of the embodiments will be described with reference to the figures which form part of the disclosure. The figures illustrate exemplary embodiments that are not intended to present an exhaustive list of embodiments of the disclosure. In the description, the same or similar reference numerals indicate the same or similar components. It is to be understood that other embodiments may be utilized and that structural or logical modifications may be made without departing from the spirit and scope of the present disclosure. Therefore, the following description is not intended to limit the scope of the disclosure, which is defined by the appended claims.

Throughout the specification, the terms “comprising”, “including”, and other similar terms used herein should be understood as open-ended terms, that is, “comprising/including but not limited to”, indicating that other elements may also be included. The term “one embodiment” refers to “at least one embodiment”, the term “another embodiment” refers to “at least one another embodiment”, and so on.

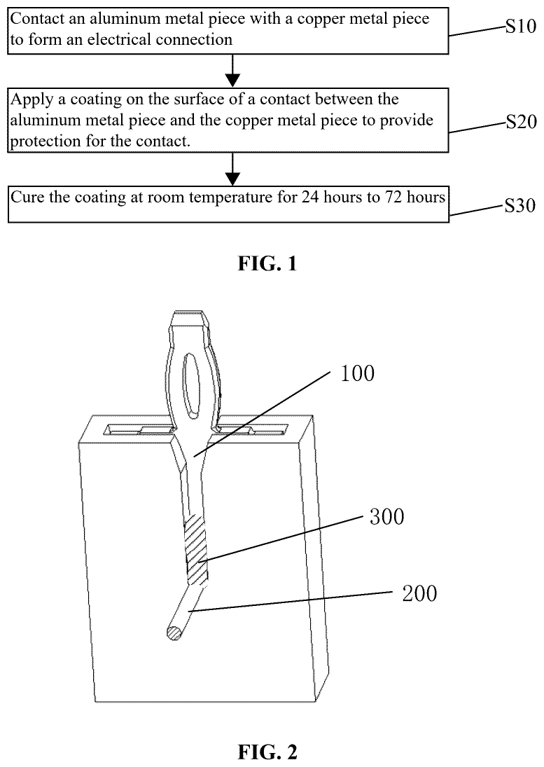

The present disclosure provides a method for providing protection for a metal joint. FIG. 1 shows an example flowchart of the method according to an embodiment of the present disclosure. The method includes steps S10-S30.

As shown in FIG. 1, Step S10 is to contact an aluminum metal piece with a copper metal piece to form an electrical connection. Step S20 is to then apply a coating 300, shown in FIG. 2, on the surface of a contact between the aluminum metal piece and the copper metal piece to provide protection for the contact. The coating 300 used in step S20 includes at least one of the following materials: polyurethane, acrylic ester, or polyolefin elastomer. Step S30 is to then cure the coating at room temperature for 24 hours to 72 hours.

In this embodiment, the aluminum metal piece is an aluminum wire core of an enameled wire 200, and the copper metal piece is a copper component of a cold-pressed terminal 100. The coating 300 is one or more coatings of a single material. In various embodiments, the coating 300 may be: (1) 1A27NSLU; (2) ITW 2104 including polyurethane; (3) 1B66NS; (4) 1B73 including acrylic ester; (5) 1B51NSLU including polyolefin elastomer; and (6) adhesive 4538.

Applying the above coating 300 at the joint point for protection makes it possible to achieve the effect of moisture resistance, salt spray resistance, and stabilizing resistance at the joint point. FIGS. 2 and 3 respectively show a schematic perspective view and a top view of applying coating 300 on the contact between the cold-pressed terminal 100 and the enameled wire 200.

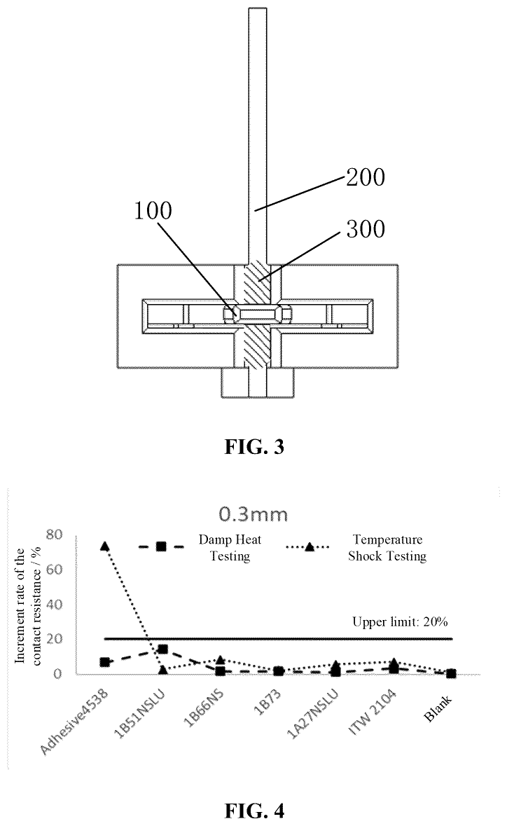

The protective effect of the coating 300 on metal joints can be confirmed by the following experimental results as shown in FIGS. 4-7.

In a first experiment of the present disclosure, the following are used as the coating 300 to conduct the experiment: a selection of two coatings of 1A27NSLU and ITW 2104 including polyurethane, two coatings of 1B66NS and 1B73 including acrylic ester, one coating of 1B51NSLU including polyolefin elastomer, one adhesive 4538, and a blank control group. In the experiment, as shown in FIGS. 2 and 3, firstly, the respective coating 300 is applied to the surface of the joint points between the cold-pressed terminal 100 and the enameled wire 200, with a coating amount of 0.01 g-0.02 g for each point. Subsequently, the damp heat testing and temperature shock testing are conducted. Finally, contact resistances of the joint points are tested to verify the protective effect.

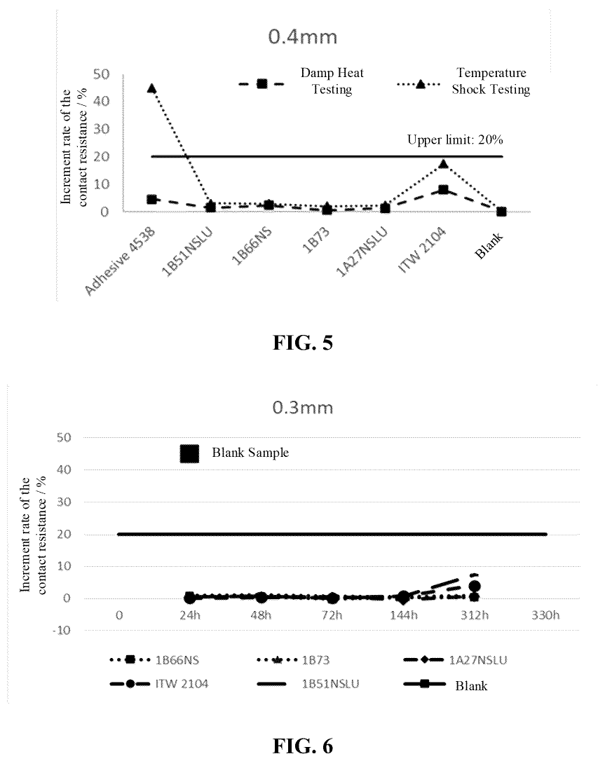

FIG. 4 shows the results of the experiment on the enameled wire 200 with a wire diameter of 0.3 mm. It can be observed that the use of the coating 300 including polyurethane, acrylic ester, or polyolefin elastomers for protection results in a small change of contact resistance at the joint points, less than 20%, after damp heat testing or temperature shock testing. The use of adhesive 4538 as the coating 300 for protection results in significant change of contact resistance at the joint point, even exceeding 20%. If no protective measures are taken at the joint point, i.e. the blank group shown in FIG. 4, the change of contact resistance at the joint point is also small after testing, less than 20%. FIG. 5 shows the results of the experiment on the enameled wire 200 with a wire diameter of 0.4 mm, which are similar to those in FIG. 4.

In another experiment of the present disclosure, the following are used as the coating 300 to conduct the experiment: a selection of two coatings of 1A27NSLU and ITW 2104 including polyurethane, two coatings of 1B66NS and 1B73 including acrylic ester, and one coating of 1B51NSLU including polyolefin elastomer, and a blank control group. In the experiment, referring to FIGS. 2 and 3, firstly, the respective coating 300 is applied to the surface of the joint points between the cold-pressed terminal 100 and the enameled wire 200, with a coating amount of 0.01 g-0.02 g for each point. Subsequently, the samples are placed in a salt spray environment for various testing times to test the contact resistances of joint points and to verify the protective effect.

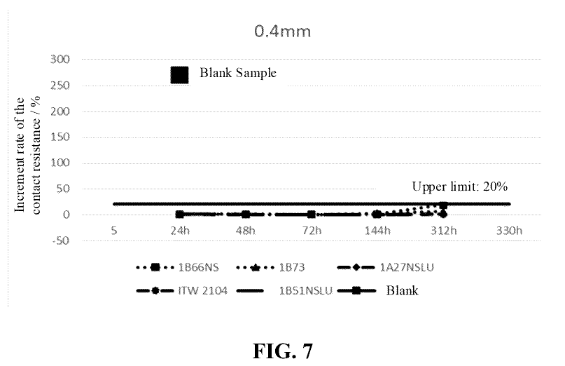

FIG. 6 shows the results of the experiment on the enameled wire 200 with a wire diameter of 0.3 mm. It can be observed that the use of the coating 300 including polyurethane, acrylic ester, or polyolefin elastomers for protection results in almost no change of contact resistance within 96 hours. When the testing time is increased to 312 hours, the change of contact resistance remains small, not exceeding the upper limit of 20%. On the contrary, if no protective measures are taken at the joint point, i.e. the blank group shown in FIG. 6, the change rate of the contact resistance exceeds 40% in a short time. FIG. 7 shows the results of the experiment on the enameled wire 200 with a wire diameter of 0.4 mm, which are similar to those in FIG. 6.

The coating 300 that is polyurethane, acrylic ester, or polyolefin elastomers has protective effects on the joint points, and by the use of such coating 300 for protection, the joint points can pass the damp heat testing, temperature shock testing, and aging testing. Optionally, the wire diameter of the enameled wire 200 on which the coating 300 is applied is 0.24 mm-0.45 mm. If the wire diameter of the enameled wire 200 is too small to form a reliable electrical connection with terminals such as the cold-pressed terminal 100, the protective effect on the joint point may be very small even if the coating 300 is applied. If the wire diameter of the enameled wire 200 is too large with a very reliable electrical connection with terminals such as the cold-pressed terminal 100, the protective effect on the joint point of the coating 300 may be not obvious.

In an embodiment, in order to be suitable for small-sized joint points between terminals such as cold-pressed terminals 100 and enameled wires 200, the coating 300 proposed in the present disclosure has low viscosity, specifically, the viscosity of the coating is less than 2000 cps.

In an embodiment, in order to reduce the curing stress of the coating 300 during the curing process to avoid damaging the electrical connections of the metal, the solid content of the coating 300 proposed in the present disclosure is less than 50%.

In an embodiment, the coating 300 proposed in the present disclosure may also include any one or more of the following solvents: xylene, ethylbenzene, propyl acetate, butyl acetate, methyl ethyl ketone, toluene, or methylcyclohexane. The solvents can adjust the viscosity of the coating 300 to achieve optimal process performance.

It should be noted that the above examples are only embodiments of the present disclosure. The present disclosure is not limited to the above embodiments and has many similar variations. All variations directly derived or associated by those skilled in the art from the present disclosure should fall within the scope of protection of the present disclosure.

In order to solve the above problems and defects, the present disclosure describes a method for providing protection for the metal joint, which has a protective effect on the contact between the copper metal piece and the aluminum metal piece.

What is claimed is:

1. A method for providing protection for a metal joint, comprising:
contacting an aluminum metal piece with a copper metal piece to form an electrical connection; and
applying a coating on a surface of a contact between the aluminum metal piece and the copper metal piece to provide protection for the contact, the coating includes one of: a polyurethane, an acrylic ester, and a polyolefin elastomer.

2. The method of claim 1, wherein the coating is the polyurethane.

3. The method of claim 1, wherein the coating is the acrylic ester.

4. The method of claim 1, wherein the coating is the polyolefin elastomer.

5. The method of claim 1, wherein the aluminum metal piece is an aluminum wire core of an enameled wire, and the copper metal piece is a copper component of a cold-pressed terminal.

6. The method of claim 1, further comprising curing the coating at room temperature for 24 hours.

7. The method of claim 1, wherein the method further comprises curing the coating at room temperature for 72 hours.

8. The method of claim 1, wherein the method further comprises curing the coating at room temperature for a time between 24 hours to 72 hours.

9. The method of claim 1, wherein a viscosity of the coating is less than 2000 cps.

10. The method of claim 1, wherein a solid content of the coating is less than 50%.

11. The method of claim 5, wherein a wire diameter of the enameled wire is 0.24 mm to 0.45 mm.

12. The method of claim 5, wherein a wire diameter of the enameled wire is 0.3 mm.

13. The method of claim 5, wherein a wire diameter of the enameled wire is 0.4 mm.

14. The method of claim 1, wherein the coating includes a solvent.

15. The method of claim 14, wherein the solvent is at least one of the following solvents: xylene, ethylbenzene, propyl acetate, butyl acetate, methyl ethyl ketone, toluene, and methylcyclohexane.

16. The method of claim 2, wherein the coating includes at least one of the following solvents: xylene, ethylbenzene, propyl acetate, butyl acetate, methyl ethyl ketone, toluene, and methylcyclohexane.

17. The method of claim 3, wherein the coating includes at least one of the following solvents: xylene, ethylbenzene, propyl acetate, butyl acetate, methyl ethyl ketone, toluene, and methylcyclohexane.

18. The method of claim 4, wherein the coating includes at least one of the following solvents: xylene, ethylbenzene, propyl acetate, butyl acetate, methyl ethyl ketone, toluene, and methylcyclohexane.
